(19) United States
(12) Patent Application Publication
(10) Pub. No.: US 2011/0156892 A1
(43) Pub. Date: Jun. 30, 2011

(54) ON-BOARD EQUIPMENT AND CONTROL METHOD THEREOF

(75) Inventor: Taira AKIYAMA, Kanagawa-ken (JP)

(73) Assignee: J&K CAR ELECTRONICS CORPORATION, Tokyo (JP)

(21) Appl. No.: 12/974,663

(22) Filed: Dec. 21, 2010

(30) Foreign Application Priority Data
Dec. 25, 2009 (JP) P2009-293888

(51) Int. Cl. B60Q 1/00

(52) U.S. Cl. 340/438

(57) ABSTRACT

An on-board equipment 1 includes a main body 2 arranged in a vehicle and an operation panel 3 detachably attached to the main body 2. The on-board equipment 1 further includes a sensor 34 for detecting whether or not the operation panel 3 has been detached from the main body 2, an indicator L1 arranged in the main body 2, a driver 22 for lighting the indicator L1 and a controller 21 for controlling the driver 22 so as to light the indicator L1 when it is detected that the operation panel 3 has been detected from the main body 2 by the sensor 34.

### BACKGROUND OF THE INVENTION

1. Field of the Invention

The present invention relates to an on-board equipment and a control method thereof.

2. Description of Related Art

In recent years, an on-board equipment with navigation function has been developed. Such an on-board equipment is mounted on a vehicle to perform a guidance operation of guide routes etc.

A vehicle equipped with an on-board equipment is apt to be carjacked or have the on-board equipment stolen during parking. Therefore, techniques for protecting a vehicle or an on-board equipment against carjack and theft or carjack have been developed.

For instance, there is a prior art where a control panel (operation unit) for an on-board equipment is provided with an indicator that is lighted up during vehicle's parking. Consequently, carjack or others to contrive to steal the on-board equipment, which will be referred to as “thief” after, is constrained to recognize that the targeted vehicle is being under an antitheft security, so that the vehicle or the on-board equipment can be protected from carjack or thief.

For an on-board equipment comprising a detachable operation unit to an equipment body secured to the interior of a vehicle, Japanese Patent Publication Laid-open No. 6-180787 also discloses a technique of giving an alarm in response to an ACC-OFF signal and a signal representing that the operation unit is not detached. Note that the “ACC-OFF” signal is a signal to represent that power supply to a vehicle's accessory, such as vehicle clock, is quitted. With the disclosed technique, it is possible to prevent a user's oblivescence of detaching the operation unit and a user's leaving of the so-detached operation unit in the vehicle. Therefore, it is possible to not only bring an on-board equipment body into an inoperable condition completely and but camouflage the presence of the on-board equipment body, improving the antitheft effect about the equipment.

### SUMMARY OF THE INVENTION

In the above-mentioned prior art on-board equipment having an operation unit detachably attached to an equipment body and also provided with an indicator, however, no indicator is provided in the equipment body. Therefore, if the operation unit is detached from the equipment body, then it becomes impossible to allow a thief to recognize the vehicle being under the supervision of security because of no indicator in the equipment body.

In the above-mentioned technique disclosed in Japanese Patent Publication Laid-open No. 6-180787, there also still remains a possibility that even after the operation unit was detached from the equipment body, a thief could not perceive such a situation of the on-board equipment, that is, detachment of the operation unit from the equipment body. In such a case, due to its reduced evocativeness to a carjack, it is impossible to protect the vehicle against the carjack and also prevent the on-board equipment from being stolen.

Under the above-mentioned situation, an object of the present invention is to provide an on-board equipment for a vehicle, which is capable of protecting the vehicle against a carjack and also preventing the on-board equipment from being stolen. Another object of the present invention is to provide a control method of such an on-board equipment.

In order to achieve the above objects, according to the first aspect of the present invention, there is provided an on-board equipment for a vehicle, comprising: an equipment main body; an operation unit detachably attached to the equipment main body; a sensor configured to detect whether or not the operation unit has been detached from the equipment main body; a first indicator arranged in the equipment main body; a driver for lighting the first indicator; and a controller configured to control the driver so as to light the first indicator when the sensor detects that the operation unit has been detected from the equipment main body.

According to the second aspect of the present invention, there is also provided a control method of an on-board equipment for a vehicle, the on-board equipment having an equipment main body, an operation unit detachably attached to the equipment main body and first and second indicators arranged in the equipment main body, the control method comprising: detecting whether or not the operation unit has been detected from the equipment main body; and lighting the first indicator when it is detected that the operation unit has been detected from the equipment main body.

### BRIEF DESCRIPTION OF THE DRAWINGS

FIG. 1 is a view showing the function of an on-board equipment in accordance with an embodiment of the present invention;

FIG. 2 is a block diagram showing an inside constitution of the on-board equipment;

FIG. 3 is a block diagram showing a controller of the on-board equipment of the present invention; and

FIG. 4 is a flow chart explaining the lighting operation.

### DESCRIPTION OF EMBODIMENTS

There will be described embodiments of the present invention with reference to drawings in detail below.

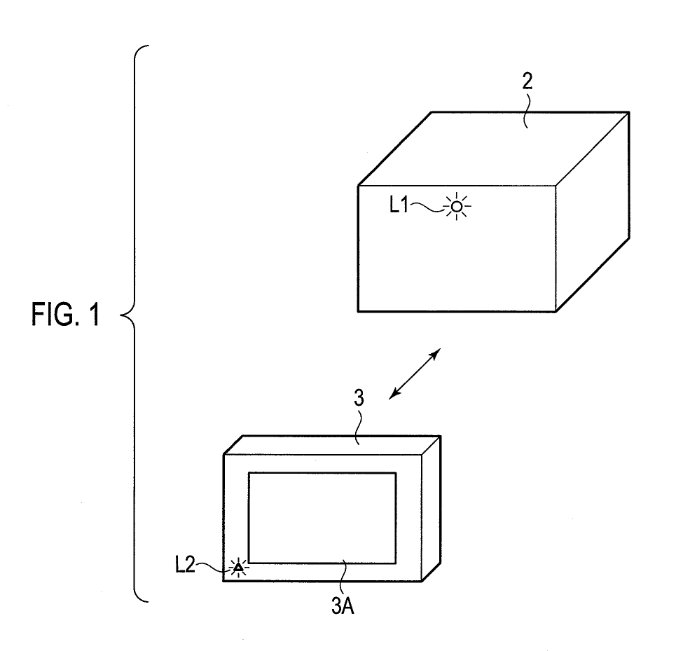

FIG. 1 shows an on-board equipment 1 in accordance with the embodiment of the invention. The on-board equipment 1 where a removable operation panel 3 is detached from a main body 2. That is, the on-board equipment 1 includes the main body 2 as an equipment main body and the operation panel 3 as an operation unit.

The main body 2 is arranged in a vehicle body (not shown). The operation panel 3 is detachably attached to a front face of the main body 2. The main body 2 is equipped with an indicator L1 as a first indicator. The indicator L1 is arranged on a PCB substrate (not shown) mounting a connector connecting the operation panel 3 with the main body 2. Regarding the positioning of the indicator L1, there is ensured a view angle so that an operator (e.g. driver) outside of the vehicle could recognize indicator's lighting under condition that the operation panel 3 is detached from the main body 2.

For instance, the operation panel 3 is formed by a touch panel. The touch panel is integrated with operation keys (not shown) and a display part 3A and also adapted so as to detect an operator's depressing on a screen of the display part 3A. The operation panel 3 is also equipped with another indicator L2 as a second indicator.

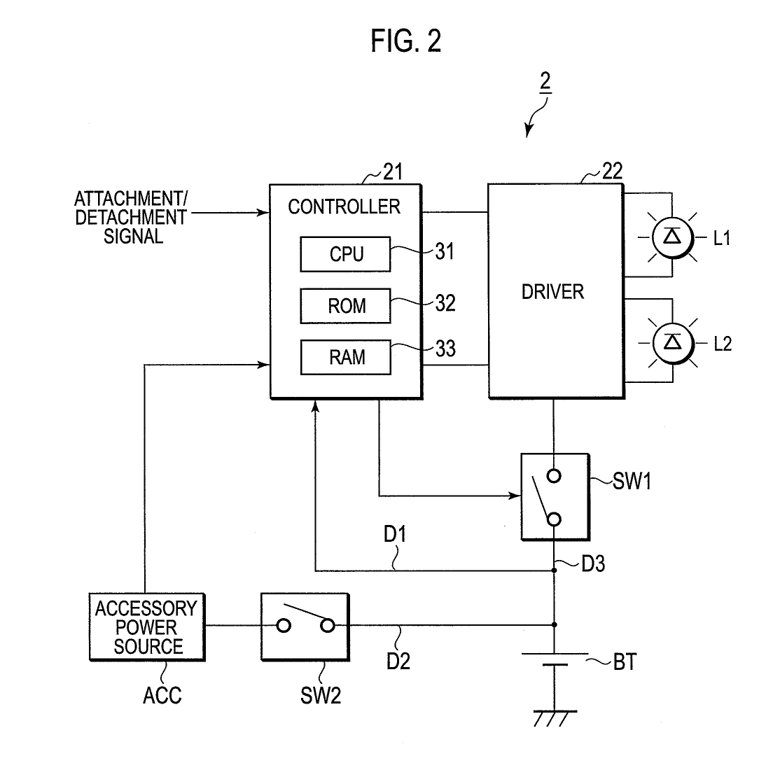

With reference to FIG. 2, the schematic constitution of the main body 2 will be described below. The main body 2 includes a controller 21, a driver 22, the above indicators L1 and L2, a switch SW1, an ignition switch SW2, an accessory power source ACC and a buttery BT.

The controller 21 includes a CPU (Central Processing Unit) 31, a RAM (Random Access Memory) 32 and a ROM (Read Only Memory) 33 to control the operations of respective sections constituting the on-board equipment 1 centrally.

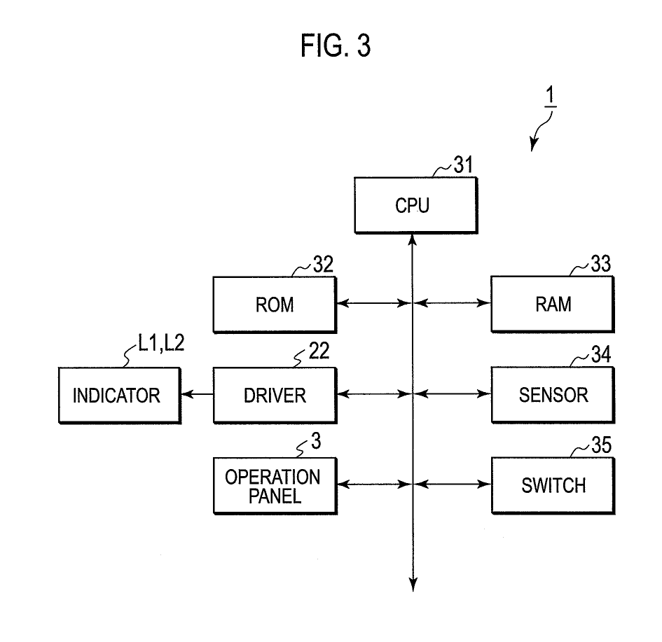

The controller 21 receives an attachment/detachment signal representing the attachment/detachment of the operation panel 3 to or from the main body 2 from a sensor 34 (see FIG. 3). For instance, if the operation panel 3 is detached from the main body 2, then the controller 21 receives, as the attachment/detachment signal, a signal representing that the operation panel 3 has been detached from the main body 2. On the other hand, if the operation panel 3 is attached to the main body 2, then the controller 21 receives, as the attachment/detachment signal, a signal representing that the operation panel 3 has been attached to the main body 2. In this way, the controller 21 is adapted so as to discriminate the attachment/detachment condition between the operation panel 3 and the main body 2.

The controller 21 also detects an ON-state of the accessory power source ACC or its OFF-state. In detail, the controller 21 detects a power current of the accessory power source ACC and judges its ON-state or OFF-state based on the detected power current.

The driver 22 operates to turn on, blink or turn off the indicators L1, L2 on the basis of an indication from the controller 21.

The indicators L1, L2 are formed by LEDs (Light Emitting Diodes) turning on, blinking or turning off based on an indication from the driver 22. By lighting or turning off the indicators L1, L2, they serve as DSI (Dummy Security Indicators) to protect a vehicle or the on-board equipment 1 against a carjack or theft.

The switch SW1 is provided to determine whether or not an electrical power from the battery BT should be supplied to the driver 22. When the switch SW1 is turned ON, the electrical power is supplied from the battery BT to the driver 22. On the contrary, when the switch SW1 is turned OFF, the power supply from the battery BT to the driver 22 is stopped. Then, the indicators L1, L2 are put out together since the power supply is brought to a stand.

The ignition switch SW2 is provided to determine whether or not an electrical power from the battery BT should be supplied to the accessory power source ACC. When the ignition switch SW2 is turned ON, the electrical power is supplied from the battery BT to the accessory power source ACC. On the contrary, when the ignition switch SW2 is turned OFF, the power supply from the battery BT to the accessory power source ACC is stopped. Again, whether the ignition switch SW2 is tuned ON or OFF depends on a user's manipulation of an ignition key (not shown).

For instance, the manipulation to turn ON the ignition switch SW2 is performed when a user starts to drive the vehicle. When the manipulation to start an engine is carried out by a user under condition that the ignition switch SW2 is turned ON, the operation of the engine (not shown) on a vehicle is started. On the other hand, the manipulation to turn OFF the ignition switch SW2 is performed, for example, when a user parks a vehicle and subsequently moves away from the vehicle. When vehicle's doors are locked by a user under condition that the ignition switch SW2 is turned OFF, the vehicle is brought into an unoccupied condition (parking condition).

The activation of the accessory power source ACC is controlled by the ignition switch SW2. If the accessory power source ACC is in its ON-state (activated), it supplies the controller 21 and vehicle's accessories (various electric components, e.g. clock, cigarette lighter, door switch and radio, all not shown) with the electrical power. While, if the accessory power source ACC is in the OFF-state (inactivated), the power supply to the controller 21 and the accessories is stopped.

The battery BT is also mounted on the vehicle to supply respective parts of the on-board equipment 1 with an electrical power through respective power lines D1, D2 and D3. Therefore, for instance, even if the ignition switch SW2 is tuned OFF and the vehicle is parked, the electrical power is supplied from the battery BT to the controller 21 and the driver 22 of the on-board equipment 1 through the power lines D1 and D3.

The control block of the on-board equipment 1 will be described with reference to FIG. 3. The on-board equipment 1 comprises the CPU 31, the ROM 32, the RAM 33, the driver 22, the indicators L1, L2, the sensor 34, the operation panel 3 and a switch 35. The CPU 31, the ROM 32 and the RAM 33 correspond to the controller 21 of FIG. 2. Note that elements similar to those of FIGS. 1 and 2 are indicated with the same reference numerals, respectively and their overlapping descriptions are eliminated. Different parts from those of FIGS. 1 and 2 will be described below.

The CPU 31 extracts a designated program from control programs stored in the ROM 32 and successively expands the extracted program in the RAM 33. Then, the CPU 31 executes a variety of operations in cooperation with the program expanded in the RAM 33.

In detail, if the detachment of the operation panel 3 from the main body 2 is detached by the sensor 34, then the CPU 31 operates the driver 22 so as to light or blink the indicator L1, in cooperation with a lighting program mentioned later.

In the ROM 32, there are stored control programs to be executed by the CPU 31, parameters required for the execution of the control programs, various data and so on. In detail, the ROM 32 stores the later-mentioned lighting program. Note that the ROM 32 may be formed by a read-only storage. Alternatively, the ROM 32 may be comprised of an optical memory medium or a semiconductor memory.

In a variety of operations executed by the CPU 31, the RAM 33 constitutes a temporary storage area for various programs, input/output data and parameters, which have been read out of the ROM 32.

The sensor 34 is formed by a mechanical or optical sensor to detect the attachment/detachment between the main body 2 and the operation panel 3. On detection of the attachment/detachment between the main body 2 and the operation panel 3, the sensor 34 outputs an attachment/detachment signal to the controller 21.

The switch 35 comprises a variety of switches in the on-board equipment 1. In detail, both the switch SW1 and the ignition switch SW2 constitute the switch 34 of FIG. 3.

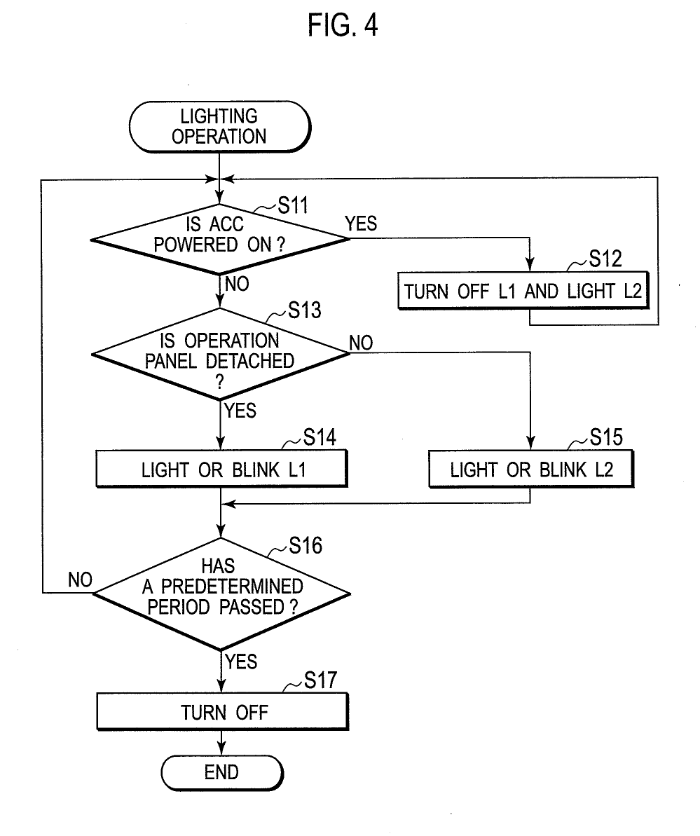

Referring to FIG. 4, a lighting operation executed by the on-board equipment 1 will be described below. Here, the lighting operation comprises a process of lighting or turning off either the indicator L1 or the indicator L2 under the judgment of whether or not the main body 2 is detached from the operation panel 3.

For instance, as soon as a flag of executing the lighting operation is detected by the CPU 31, it performs the lighting operation in accordance with the lighting program read out of the ROM 32 and expanded in the RAM 33 appropriately.

FIG. 4 is a flow chart of the lighting program performed by the CPU 31. At first, at step S11, it is executed to judge whether or not the accessory power source ACC is powered ON. In detail, a power current of the accessory power source ACC is detected by the CPU 31 and successively, the judgment at step S11 is performed on the basis of the detected power current, by the CPU 31.

If it is judged at step S11 that the accessory power source ACC is powered ON (Yes at step S11), the routine goes to step S12 where the indicator L1 is turned off and the indicator L2 is turned on. The CPU 31 transmits a command of switching on the switch SW1. Consequently, the power from the battery BT to the driver 22 is supplied. The driver 22 turns off the indicator L1 while turning on the indicator K2. Here it is preferable that the luminance of the lighting or blinking indicator L2 at step 12 is lower than that of the lighting indicator L2 at step 15 described below. Alternatively, the CPU 31 can transmit a command of switching off the switch SW1, and consequently the power supply from the battery BT to the driver 22 is stopped to put the indicators L1, L2.

If the judgment at step S11 is No, that is, when it is judged that the accessory power source ACC is not powered ON, then the routine goes to step S13 where it is executed to judge whether or not the operation panel 3 is detached from the main body 2. In detail, the judgment at step S13 is performed on the basis of the judgment of whether the CPU 31 has detected an attachment/detachment signal representing that the operation panel 3 is being detached from the main body 2.

If it is judged at step S13 that the operation panel 3 is being detached from the main body 2 (judgment “Yes” at step S13), then the routine goes to step S14 where the indicator L1 in the main body 2 is lighted or blinked. In detail, the CPU 31 transmits a command of lighting or blinking the indicator L1 to the driver 22. Upon receiving of the command, the driver 22 operates to light or blink the indicator L1. After executing the operation at step S14, the routine goes to step S16.

If it is judged at step S13 that the operation panel 3 is not detached from the main body 2 (judgment “No” at step S13), then the routine goes to step S15 where the indicator L2 in the operation panel 3 is lighted or blinked. In detail, the CPU 31 transmits a command of lighting or blinking the indicator L2 to the driver 22. Upon receiving of the command, the driver 22 operates to light or blink the indicator L2. After executing the operation at step S15, the routine goes to step S16. Here it is preferable that the luminance of the lighting or blinking indicator L2 at step 15 is higher than that of the lighting indicator L2 at step 12.

At sequent step S16, it is executed to judge whether or not a predetermined period after executing the lighting operation at step S14 or S15 has passed. In detail, upon establishment of a base time when the ignition switch SW2 is turned OFF as a standard, it is executed to count an elapsed time from the base time by a not-shown timer. Further, it is also executed to judge whether or not the resulting elapsed time has exceeded a predetermined period (e.g. one month).

If it is judged at step S16 that the elapsed time has not exceeded the predetermined period (judgment “No” at step S 16), then the routine returns to step S11. On the contrary, if is judged at step S16 that the elapsed time has exceeded the predetermined period (judgment “Yes” at step S16), the routine goes to step S17 where the indicators L1, L2 are turned off. In detail, the CPU 31 transmits the command of switching off the switch SW1. Consequently, the power supply from the battery BT to the driver 22 is stopped to put the indicators L1, L2 off. In this way, the power consumption of the battery during disusing the vehicle is prevented. After executing the operation at step S17, the lighting operation is ended.

According to the embodiment mentioned above, in this way, when it is detected that the operation panel 3 has been detached from the main body 2, the indicator L1 is lighted up or blinked in the main body 2. Consequently, as the on-board equipment 1 could allow a thief to recognize the vehicle being under the supervision of security even if the operation panel 3 is detached from the main body 2, it is possible to protect the vehicle against a carjack and also prevent the on-board equipment from being stolen.

In addition, if it is detected that the operation 3 is not detached from the main body 2, the indicator L2 is lighted up or blinked in the operation panel 3. Consequently, as the on-board equipment 1 could allow a thief to recognize the vehicle being under the supervision of security even if a user carelessly forgets to detach the operation panel 3 from the main body 2, it is possible to protect the vehicle against a carjack and also prevent the on-board equipment from being stolen.

Finally, it will be understood by those skilled in the art that the foregoing descriptions are nothing but one embodiment of the disclosed on-board equipment 1, and therefore various changes and modifications about its detailed structure and operation may be made within the scope of claims.

What is claimed is:

1. An on-board equipment for a vehicle, comprising:
an equipment main body;
an operation unit detachably attached to the equipment main body;
a sensor configured to detect whether or not the operation unit has been detached from the equipment main body;
a first indicator arranged in the equipment main body;
a driver configured to light the first indicator; and
a controller configured to control the driver so as to light or blink the first indicator when the sensor detects that the operation unit has been detected from the equipment main body.

2. The on-board equipment of claim 1, further comprising a second indicator arranged in the operation unit, wherein:
the driver is also configured to light or blink the second indicator; and
the controller controls the driver so as to light or blink the second indicator when the sensor does not detect that the operation unit has been detected from the equipment main body.

3. The on-board equipment of claim 1, wherein
when an accessory power source of the vehicle mounting the on-board equipment is powered ON, the controller controls the driver so as to put the first indicator off.

4. The on-board equipment of claim 2, wherein
when an accessory power source of the vehicle mounting the on-board equipment is powered ON, the controller controls the driver so as to put the second indicator on.

5. A control method of an on-board equipment for a vehicle, the on-board equipment having an equipment main body, an operation unit detachably attached to the equipment main body and first and second indicators arranged in the equipment main body, the control method comprising:
detecting whether or not the operation unit has been detected from the equipment main body; and
lighting or blinking the first indicator when it is detected that the operation unit has been detected from the equipment main body.

6. The control method of the on-board equipment according to claims 5, further comprising:
lighting or blinking the second indicator when it is not detected that the operation unit has been detected from the equipment main body.

7. The control method of the on-board equipment according to claim 5, further comprising:
detecting whether or not an accessory power source of the vehicle mounting the on-board equipment is powered ON; and
putting the first indicator off if it is detected that the accessory power source is powered ON.

8. The control method of the on-board equipment according to claim 6, further comprising:
detecting whether or not an accessory power source of the vehicle mounting the on-board equipment is powered ON; and
putting the second indicator on if it is detected that the accessory power source is powered ON.

9. The control method of the on-board equipment according to claims 7, further comprising:
counting a period of lighting the first indicator since the accessory power source of the vehicle mounting the on-board equipment is powered OFF; and
putting the first indicator off if the period of lighting or blinking the first indicator exceeds a predetermined value.

10. The control method of the on-board equipment according to claims 8, further comprising:
counting a period of lighting the second indicator since the accessory power source of the vehicle mounting the on-board equipment is powered OFF; and
putting the second indicator off if the period of lighting or blinking the first indicator exceeds a predetermined value.
